(19) United States
(12) Patent Application Publication
(10) Pub. No.: US 2005/0270384 A1
(43) Pub. Date: Dec. 8, 2005

(54) IMAGE-CAPTURING APPARATUS WITH AN ERROR-DETECTING FUNCTION

(76) Inventors: Yen-Cheng Chen, Hsin-Chu City (TW); CHIEN-HUNG CHEN, Hsin-Chu City (TW); Chia-Chan Chang, Kao-Hsiung City (TW)

Correspondence Address: NORTH AMERICA INTELLECTUAL PROPERTY CORPORATION, P.O. BOX 506, MERRIFIELD, VA, 22116, US

(21) Appl. No.: 10/711,062

(22) Filed: Aug. 20, 2004

(30) Foreign Application Priority Data
Jun. 2, 2004 (TW) 093115846

(51) Int. Cl. H04N 5/76

(52) U.S. Cl. 348/231.3

(57) ABSTRACT

An image-capturing device includes a light sensor for sensing light reflected from an image, an analog front-end device, an encoder, a decoder, a processor, and a signal transmission device. The encoder encodes a digital image signal generated by the analog front-end device. The decoder decodes an encoded digital image signal encoded by the encoder from the digital image signal.

### BACKGROUND OF INVENTION

1. Field of the Invention

The present invention relates to an image-capturing apparatus, and more particularly, to an image-capturing apparatus with an error-detecting function.

2. Description of the Prior Art

In recent years, image-capturing apparatuses, such as copy machines, multi-function products (MFP), and digital still cameras (DSC), have been widely applied to a variety of fields in accordance with the explosive development of Internet. A user is capable of transmitting an image captured by an image-capturing apparatus via Internet to a friend thousands of miles away.

Please refer to FIG. 1, which is a function block diagram of an image-capturing apparatus 10 according to the prior art. The image-capturing apparatus 10 comprises a light engine 12, a control and data-processing unit 16, a signal transmission device 14, and a step motor 18. The light engine 12 comprises a charge-coupled device (CCD) module 20 installed for sensing light reflected from an image and for transforming the light into an analog image signal. The signal transmission device 14 transmits the analog image signal to the control and data-processing unit 16. The step motor 18 is electrically connected between the light engine 12 and the control and data-processing unit 16 for controlling the movement of the light engine 12 according to control signals generated by the control and data-processing unit 16.

The control and data-processing unit 16 comprises an analog front-end device 22, an application-specific integrated circuit (ASIC) 24, and a memory 26. The analog front-end device 22 transforms the analog image signal transmitted over the signal transmission device 14 into a digital image signal. The ASIC 24 is electrically connected to the analog front-end device 22 for executing on the digital image signal a variety of digital signal processes such as a noise-cleaning process and an image-compressing process. The memory 26 is electrically connected to the ASIC 24 for storing the processed digital image signal processed by the ASIC 24. The ASIC 24 further has a capability to control the CCD module 20 to re-sense light reflected from another image by generating a re-capturing signal and transmitting the re-capturing signal via the signal transmission device 14 to the CCD module 20 of the light engine 12.

In a process of being transmitted over the signal transmission device 14, the analog image signal suffers electromagnetic interference (EMI) and is easily distorted.

Please refer to FIG. 2, which is a function block diagram of another image-capturing apparatus 30 according to the prior art. The image-capturing apparatus 30 comprises a light engine 32, the signal transmission device 14, a control and data-processing unit 36, and the step motor 18. Although the image-capturing apparatus 30 also comprises the CCD module 20, the signal transmission device 14, the analog front-end device 22, the ASIC 24, the memory 26, and the step motor 18, similar to the image-capturing apparatus 10, the analog front-end device 22 of the image-capturing apparatus 30 is installed in the light engine 12 rather than in the control and data-processing unit 16, where the analog front-end device 22 of the image-capturing apparatus 10 is installed. Therefore, what is being transmitted over the signal transmission device 14 is not the analog image signal but the digital image signal instead, which is robust enough to survive EMI.

However, the signal transmission device 14 electrically connected between the light engine 12 and the control and data-processing unit 16 usually does not have too short a length, and a signal transmitted over such a signal transmission device is easily contaminated by noises even if the signal is a digital image signal, so the control and data-processing unit 36 of the image-capturing apparatus 30 still has a big chance to receive a wrong signal.

### SUMMARY OF INVENTION

It is therefore a primary objective of the claimed invention to provide an image-capturing apparatus with error-detecting function to solve the drawbacks of the prior art.

According to the claimed invention, the image-capturing apparatus includes a light sensor, an analog front-end device, an encoder, a decoder, a processor, and a signal transmission device. The light sensor senses light reflected from an image and transforms the light into an analog image signal. The analog front-end device is electrically connected to the light sensor and transforms the analog image signal into a digital image signal. The encoder is electrically connected to the analog front-end device and encodes the digital image signal transformed by the analog front-end device. The decoder decodes the encoded digital image signal encoded by the encoder. The processor is electrically connected to the decoder for determining whether the encoded digital image signal encoded by the encoder is correct or not and for generating a control signal to control the operations of the light sensor and the encoder. The signal transmission device is electrically connected between the light sensor, the decoder, and the processor for transmitting the encoded digital image signal encoded by the encoder and the control signal generated by the processor.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a function block diagram of an image-capturing apparatus according to the prior art.

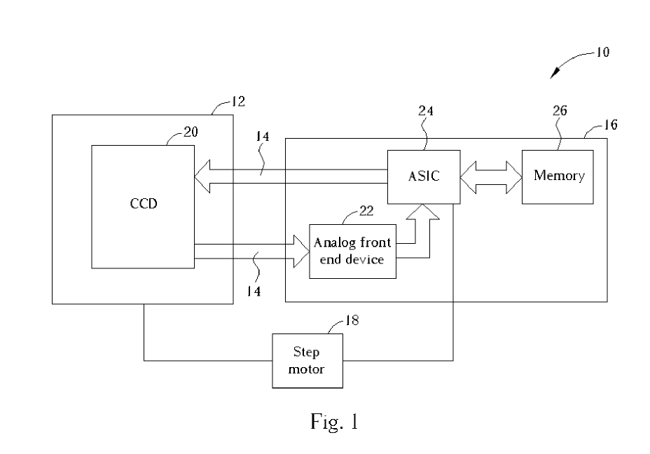

FIG. 2 is a function block diagram of another image-capturing apparatus according to the prior art.

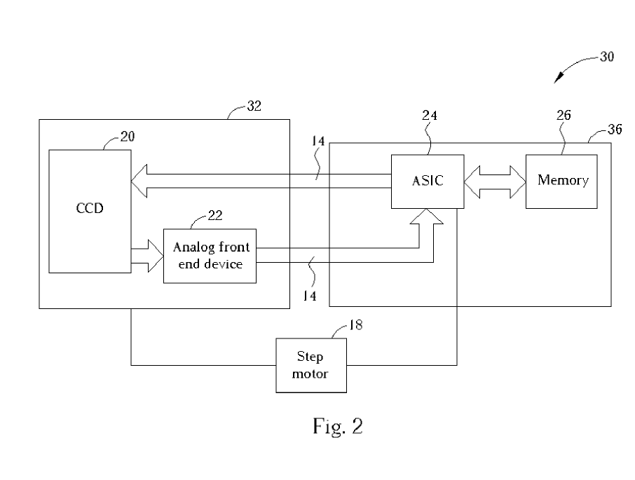

FIG. 3 is a function block diagram of an image-capturing apparatus of the preferred embodiment according to the present invention.

FIG. 4 is a function block diagram of an image-capturing apparatus of a second embodiment according to the present invention.

### DETAILED DESCRIPTION

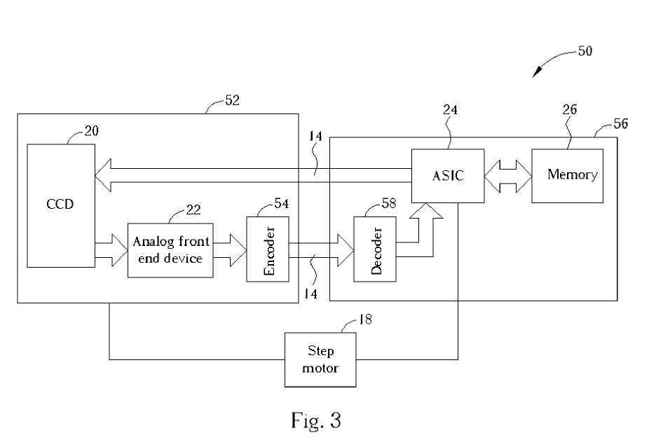

An image-capturing apparatus with an error-detecting function to determine whether a signal transmitted in the image-capturing apparatus is correct or not is described in the following paragraphs. Please refer to FIG. 3, which is a function block diagram of an image-capturing apparatus 50 of the preferred embodiment of the present invention. The image-capturing apparatus 50 comprises the signal transmission device 14, a light engine 52 electrically connected to the signal transmission device 14, a control and data-processing unit 56 electrically connected to the signal transmission device 14, and the step motor 18, which is electrically connected between the control and data-processing unit 56 and the light engine 52.

The light engine 52 comprises the CCD module 20, the analog front-end device 22 that is electrically connected to the CCD module 20, and an encoder 54 electrically connected to the analog front-end device 22 for encoding the digital image signal transformed by the analog front-end device 22 into an encoded digital image signal, which can be transmitted over the signal transmission device 14 to the control and data-processing unit 56.

The control and data-processing unit 56 comprises a decoder 58 electrically connected to the signal transmission device 14 for decoding the encoded digital image signal transmitted over the signal transmission device 14, the ASIC 24, which is electrically connected to the decoder 58, and the memory 26, which is electrically connected to the ASIC 24. In addition to execute the noise-cleaning process and the image-compressing process, the ASIC 24 further has a capability to determine whether the encoded digital image signal transmitted over the signal transmission device 14 is correct or not and to control the CCD module 20 to re-sense light reflected from another image by generating a re-capturing signal and transmitting the re-capturing signal via the signal transmission device 14 to the CCD module 20 of the light engine 52.

The ASIC 24 does not generate any re-capturing signal if the encoded digital image signal is determined correct. On the other hand, if the encoded digital image signal is determined to be incorrect, the ASIC 24 generates and transmits the re-capturing signal via the signal transmission device 14 to the light engine 52 and controls the CCD module 20 of the light engine 52 to re-sense light reflected from another image.

According to the preferred embodiment, the encoder 54, the decoder 58, and the ASIC 24 can form an odd parity error-checking mechanism, an even parity error-checking mechanism, or a cyclic-redundancy error-checking (CRC) mechanism, or any other error-checking mechanism.

For example, if the encoder 54, the decoder 58, and the ASIC 24 are assumed to form an odd parity error-checking mechanism, the encoder 54 appends a check code having a predetermined number of bits to the digital image signal transformed by the analog front-end device 22 to restrict the encoded digital image signal (the digital image signal including the check code) to have an odd number of bits equal to “1”. The encoded digital image signal plus check code is then transmitted to the control and data-processing unit 56 via the signal transmission device 14. Then, the ASIC 24 executes the noise-cleaning process (or the image-compressing process) after determining that the number of bits equal to “1” in the encoded digital image signal is odd. If the number of bits equal to “1” in the encoded digital image signal is even, the ASIC 24 transmits the re-capturing signal via the signal transmission device 14 to the light engine 52 to control the CCD module 20 of the light engine 52 to re-sense light reflected from another image.

The ASIC 24 of the image-capturing apparatus 50 transmits the re-capturing signal to the light engine 52 after determining that the encoded digital image signal is incorrect. However, after determining that an encoded digital image signal is incorrect, an ASIC of an image-capturing apparatus of the present invention can still get a correct encoded digital image signal by parsing the incorrect encoded digital image signal directly, without transmitting the re-capturing signal.

For example, if a digital image signal ready to be encoded by the encoder 54 is assumed to be “0110”, the encoder 54 encodes the digital image signal of “0110” into an encoded digital image signal of “001111001”, which has a first, a third, a fifth, and a seventh bit equal to a first, a second, a third, and a fourth bit of the digital image signal respectively, a second, a fourth, a sixth, and an eighth bit equal to the first, the second, the third, and the fourth bit of the digital image signal respectively, and a ninth bit equal to “1”, which is set according to the digital image signal “0110” and the odd parity error-checking mechanism. After determining that the first, the third, the fifth, and the seventh bit are respectively equal to the second, the fourth, the sixth, and the eighth bit of the encoded digital image signal, the ASIC 24 can ignore the ninth bit and determines that the first, the third, the fifth, and the seventh bit of the encoded digital image signal are equal to the first, the second, the third, and the fourth bit of the digital image signal.

On the other hand, if any bit in an odd group consisting of the first, the third, the fifth, and the seventh bit is not equal to a respectively corresponding bit in an even group consisting of the second, the fourth, the sixth, and the eighth bit of the encoded digital image signal, the ASIC 24 refers to the ninth bit of the encoded digital image signal and determines the digital image signal accordingly. For example, if the encoded digital image signal that the decoder 58 received is “001011001”, which has a third bit not equal to a fourth bit, after determining that the third bit or the fourth bit of the encoded digital image signal is incorrect, the ASIC 24 determines that the digital image signal is “0110” rather than “0010” according to the ninth bit and the odd parity error-checking mechanism.

According to such a scenario described above, the image-capturing apparatus is not only capable of determining the correctness of an encoded digital image signal, the image-capturing apparatus also has a capability to recovery an incorrect encoded digital image signal into a correct digital image signal, without the necessity of transmitting the re-capturing signal. In equivalence, the ASIC 24 is transmitting nothing but a null signal not to enable the light engine 52 to operate.

According to the preferred embodiment, the CCD module 20, the analog front-end device 22, and the encoder 54 are all installed in the light engine 12. Any kind of light sensor having the capability to sense light reflected from an image and to transform the reflected light into an analog image signal can be substituted for the CCD module 20. However, the analog front-end device 54 and the encoder 54 can be selectively installed on a motherboard.

After determining that the encoded digital image signal transmitted over the signal transmission device 14 is incorrect, the ASIC 24 of the image-capturing apparatus 50 shown in FIG. 3 generates and transmits the re-capturing signal, which enables the CCD module 20 to re-sense light reflected from another image, to the light engine 52. However, an ASIC of an image-capturing apparatus of the present invention can still get the correct encoded digital image signal without enabling the CCD module 20 to resensing light of another image.

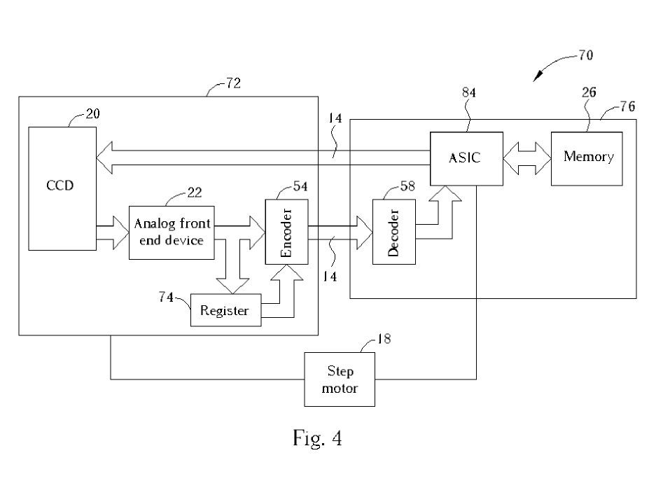

Please refer to FIG. 4, which is a function block diagram of an image-capturing apparatus 70 of a second embodiment according to the present invention. The image-capturing apparatus 70 comprises the signal transmission device 14, a light engine 72 electrically connected to the signal transmission device 14, a control and data-processing unit 76 electrically connected to the signal transmission device 14, and the step motor 18, which is electrically connected between the light engine 72 and the signal transmission device 76.

In addition to the CCD module 20, the analog front-end device 22 and the encoder 54, the light engine 72 further comprises a register 74 electrically connected between the analog front-end device 22 and the encoder 54 for storing the digital image signal transformed by the analog front-end device 22 from the analog image signal transformed by the CCD module 20. Every time a new digital image signal is generated, the analog front-end device 22 updates the digital image signal stored in the register 74 with the new digital image signal.

Similarly, an ASIC 84 of the control and data-processing unit 76 is also capable of executing the noise-cleaning process on an encoded digital image signal encoded by the encoder 58. However, the ASIC 84 transmits a re-encoding signal, instead of the re-capturing signal, via the signal transmission device 14 to the light engine 72 to enable the encoder 54 to re-encode the digital image signal stored in the register 74.

After determining that the encoded digital image signal transmitted over the signal transmission device 14 is correct, the ASIC 84 does nothing. On the other hand, if the ASIC 84 determines that the encoded digital image signal is incorrect, the ASIC 84 transmits the re-encoding signal to the light engine 72 to enable the encoder 54 to re-encode the digital image signal stored in the register 74. Since a digital image signal transmitting rate of the signal transmission device 14, a digital signal processing rate of the ASIC 84, and a correctness determining rate of the ASIC 84 are all far higher than an image-capturing rate of the CCD module 20, and the image-capturing rate approximately equal to a digital image signal generating rate of the analog front-end device 22, during a period when the ASIC 84 determines that the encoded digital image signal is incorrect and transmits the re-encoding signal to the light engine 72, the analog front-end device 74 does not have enough time to generate another digital image signal, and the digital image signal stored in the register 74 is remained unchanged. Therefore, the digital image signal that the encoder 54 encodes according to the re-encoding signal is identical to the digital image signal just transmitted to the decoder 58.

In contrast to the prior art, the present invention can provide an image-capturing apparatus comprising an encoder and a corresponding decoder. The image-capturing apparatus has a better reliability with the help of an error-detecting function formed according to the encoder and the decoder.

Those skilled in the art will readily observe that numerous modifications and alterations of the device and method may be made while retaining the teachings of the invention. Accordingly, the above disclosure should be construed as limited only by the metes and bounds of the appended claims.

1. An image-capturing apparatus with error-detecting function, the image-capturing apparatus comprising:
a light sensor for sensing light reflected from an image and for transforming the light into an analog image signal;
an analog front-end device electrically connected to the light sensor for transforming the analog image signal into a digital image signal;
an encoder electrically connected to the analog front-end device for encoding the digital image signal transformed by the analog front-end device;
a decoder for decoding the encoded digital image signal encoded by the encoder;
a processor electrically connected to the decoder for determining whether the encoded digital image signal encoded by the encoder is correct or not and for generating a control signal to control the operations of the light sensor and the encoder; and
a signal transmission device electrically connected between the light sensor, the decoder, and the processor for transmitting the encoded digital image signal encoded by the encoder and the control signal generated by the processor.

2. The image-capturing apparatus of claim 1, wherein the processor is to generate the control signal only if the processor has determined that the encoded digital image signal encoded by the encoded is not correct.

3. The image-capturing apparatus of claim 1, wherein the control signal enables the light sensor to sense light reflected from another image.

4. The image-capturing apparatus of claim 1 further comprising a register electrically connected between the analog front-end device and the encoder for storing the digital image signal transformed by the analog front-end device.

5. The image-capturing apparatus of claim 4, wherein every time the analog front-end device transforms a new analog image signal into a new digital image signal, the analog front-end device updates the digital image signal stored in the register with the new digital image signal.

6. The image-capturing apparatus of claim 5, wherein the control signal enables the encoder to encode the digital image signal stored in the register.

7. The image-capturing apparatus of claim 1, wherein the encoder, the decoder, and the processor form an odd parity error-checking mechanism.

8. The image-capturing apparatus of claim 1, wherein the encoder, the decoder, and the processor form an even parity error-checking mechanism.

9. The image-capturing apparatus of claim 1, wherein the encoder, the decoder, and the processor form a cyclic-redundancy error-checking (CRC) mechanism.

10. The image-capturing apparatus of claim 1, wherein the digital image signal comprises N bits, and the encoded digital image signal encoded by the encoder from the digital image signal comprises a check bit having a value set according to the N bits of the digital image signal and a predetermined error-checking mechanism formed according to the encoder, the decoder, and the processor, and N corresponding bit pairs, each of the bit pairs comprising an odd location bit and an even location bit equal to the odd location bit, and an odd location bit of an nₜₕ bit pair of the encoded digital image signal having a value equal to that of an nₜₕ bit of the digital image signal.

11. The image-capturing apparatus of claim 10, wherein the control signal is a null signal.

12. The image-capturing apparatus of claim 10, wherein the predetermined error-checking mechanism is an odd parity error-checking mechanism.

13. The image-capturing apparatus of claim 10, wherein the predetermined error-checking mechanism is an even parity error-checking mechanism.

14. The image-capturing apparatus of claim 10, wherein the predetermined error-checking mechanism is a cyclic-redundancy error-checking mechanism.

15. The image-capturing apparatus of claim 1, wherein the processor is an application-specific integrated circuit (ASIC).

16. The image-capturing apparatus of claim 1, wherein the light sensor is a charge-coupled device (CCD).

17. The image-capturing apparatus of claim 1, wherein the analog front-end device is installed in a light engine comprising the light sensor.

18. The image-capturing apparatus of claim 1, wherein the encoder is installed in a light engine comprising the light sensor.

19. The image-capturing apparatus of claim 1, wherein the analog front-end device is installed on a motherboard.

20. The image-capturing apparatus of claim 1, wherein the encoder is installed on a motherboard.
